(19) United States
(12) Patent Application Publication
(10) Pub. No.: US 2009/0070752 A1
(43) Pub. Date: Mar. 12, 2009

(54) METHOD AND SYSTEM FOR OPTIMIZATION OF AN APPLICATION

(75) Inventors: BOWEN L. ALPERN, Peekskill, NY (US); Glenn Ammons, Albany, NY (US); Joshua S. Auerbach, Ridgefield, CT (US); Vasanth Bala, Rye, NY (US); Thomas V. Frauenhofer, Stony Point, NY (US); Todd W. Mummert, Danbury, CT (US); Darrell C. Reimer, Tarrytown, NY (US)

Correspondence Address: FLEIT GIBBONS GUTMAN BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 11/850,908

(22) Filed: Sep. 6, 2007

(51) Int. Cl. G06F 9/45

(52) U.S. Cl. 717/148

(57) ABSTRACT

A method is provided for creating a virtual machine image. According to the method, at least one application is provided on a computer system. After the application is provided on the computer system, at least one optimization of the application is performed based on a runtime environment of the application to produce an optimized application, and the optimized application and at least a portion of the runtime environment are packaged in a virtual machine image. In one embodiment, the computer system is a virtual machine. Also provided is a system for creating a virtual machine image.

### FIELD OF THE INVENTION

The present invention relates generally to virtual machines, and more particularly to methods and systems for creating optimized virtual machine images.

### BACKGROUND OF THE INVENTION

The use of virtualization as a software abstraction of the underlying hardware machine was developed by IBM Corporation in the 1960s. Virtualization refers to the interception of an application's communication with its underlying runtime platforms such as the operating system (OS) or a Java Virtual Machine (JVM). Virtualization can be used to give an application the illusion that it is running in the context of its install machine, even though it is executing in the (possibly different) context of a host execution machine.

Conventional full-system virtualization techniques emulate a hardware machine on which an operating system (possibly distinct from that of the host execution machine) can be booted. Full system virtualization incurs a significant performance penalty, and is primarily intended for testing and porting across different operating system platforms. Assuming that installed images are always platform specific (e.g., a Windows/x86 and a Linux/x86 application will each have a separate platform-specific installed image), then much of the host execution machine's operating system and hardware interfaces can be used directly without virtualization. This selective virtualization approach incurs significantly lower performance overhead than full-system virtualization and is practically indistinguishable from direct execution performance.

Virtual machines (VMs), particularly those that attempt to capture an entire machine's state, are increasingly being used as vehicles for deploying software, providing predictability and centralized control. The virtual environment provides isolation from the uncontrolled variability of target machines, particularly from potentially conflicting versions of prerequisite software. Skilled personnel assemble a self-contained software universe (potentially including the operating system) with all of the dependencies of an application, or suite of applications, correctly resolved. This insures that this software will exhibit the same behavior on every machine. A Virtual Machine Monitor (VMM) is interposed between it and the real machine.

A spectrum of virtual machines are in use today. These range from runtime environments for high-level languages, such as Java and Smalltalk, to hardware-level VMMs, such as VMware and Xen.

Because software deployment is a relatively new motivation for using virtual machine technology, today's VM-based software deployment efforts employ VMs that were originally designed for other purposes, such as crash protection, low-level debugging, process migration, system archival, or OS development, and are being re-purposed for software deployment.

Many users today require their own virtual machine images which are specific to their own software or computing needs. However, deployment can often be complicated particularly in those instance in which several different applications produced by separate software organizations need to be integrated on the same machine. An example of such a scenario could be a suite such as MySQL/JBOSS/Tomcat/Apache, a Java development tool such as Eclipse, and a J2EE application that needs to be developed using Eclipse and tested on the MySQL/JBOSS/Tomcat/Apache suite.

Such a complex collection of applications may often have conflicting pre-requisites. Each application may require its own version of the JVM, for example, or depend on specific patch-levels of certain dependent components. VMMs can help alleviate such conflicts by allowing each application's dependencies to be embedded in its private VM image. Vendors deal with dependency conflicts in more or less the same way. Vendors try to reduce dependency conflicts by embedding the application's dependencies into the application installed image, usually without the benefit of VM technology. For example, Eclipse version 2.x comes bundled with Tomcat, which is used for rendering the Eclipse help pages. Similarly, JBOSS distributions also include an embedded version of Tomcat. Many commercial Java middleware products embed one or more JVMs in their images. This trend has also been reflected within a single software product. For example, the module “org.apache.xerces” is often duplicated in several different components in an effort to isolate these components more fully from one another. A VMM can guarantee that the isolation between conflicting software stacks is provably complete, lacking in subtle holes.

But, whether assisted by a VMM or not, incorporation of dependencies without any compensating measures results in increasing software bloat. From a disk space perspective, tolerating bloat is no longer a relatively large problem. However, an isolation strategy accomplished through physical code duplication creates other problems, such as slowing down the deployment process, and increasing the number of components that need to be configured at deployment time or touched during subsequent updates. It may also increase the customer's perception of an application's complexity, which in turn increases the customer's reluctance to update frequently. This can result in a proliferation of software versions in the field and increasing support and service costs over time.

Also, data center environments are increasingly moving toward a scale-out model in which large farms of several thousand commodity servers are becoming commonplace. In such scenarios, hardware failures can occur frequently, often several times a day. The cost of commodity hardware is relatively low so operators can often deal with hardware failures by simply replacing the defective machine on a rack, and re-provisioning the new machine with the application suite. Large commercial software stacks can take hours to provision, thus increasing the cost of such failures.

Using any VMM to help with provisioning can speed this up by replacing the normal installation process with an easily-moved image. But, unless specific steps are taken to deal with the underlying code bloat, just the process of moving the bits may cause slowdown. Reversing the trend toward increasing code bloat due to duplication-based isolation techniques might prove valuable in such situations. A properly engineered solution may also take into account that a software application can usually begin executing when only a fraction of its bits are present.

A software deployment system assumes that the software it deploys in one offering is not the only software offering deployed on the target machine. Each machine owner assembles a palette of offerings. These offerings must be able to inter-operate both via system-mediated communication channels (e.g., semaphores, pipes, and shared memory) and via files in a common file system.

For example, for a VMM-assisted deployment, if all offerings were run in the same VM instance, the isolation advantages of using a VM will be lost because the offerings might then conflict. But, if each offering is run in a different VM instance using the usual hardware virtualization paradigm, the inter-operation between offerings takes on characteristics of inter-machine communication rather than intra-machine communication. What seems like one machine to the user is now laced with remote file mounts and distributed protocols. Somehow, the degree of isolation must be relaxed to permit a more local style of inter-operation. The relaxation must be done while still managing conflicts and reducing variability in the areas that matter to correct execution.

Making this change involves tradeoffs. A more porous isolation between VMs enhances the user experience when integrating software on a single machine. However, other characteristics that one might expect from a general-purpose VMM (such as crash protection or the ability to freeze and migrate processes) might be sacrificed.

The level of indirection provided by the VM layer enables the software running above it to be decoupled from the system beneath it. This decoupling enables the VM layer to control or enhance the software running above it. A VMM, such as VMware, seeks to exploit the decoupling to fully isolate the software stack running above it from the host environment, thus enabling sandboxed environments for testing, archival, and security. The VMM is often used to capture both the persistent and volatile state of a sandboxed environment to enable mobility of end-user environments over a network. Further, the VMM has been exploited for simplifying the deployment and maintenance of software environments. Utilities like Debian simplify the maintenance of software packages but do not provide isolation in the sense of enabling conflicting versions of a component to co-exist in the same (virtual) namespace.

Managed container frameworks like J2EE and .NET provide network deployment and management features, but they are language specific, and require the use of framework APIs. Other language-specific solutions for software deployment and maintenance are Java Web Start and OSGi. Zap is an implementation of a virtualization layer between the operating system and the software. One of the objectives of Zap is the migration of process groups across machines, not software deployment and serviceability. Others, such as AppStream, Endeavors, and Softricity, use file-system based approaches to provide centrally managed software deployment and maintenance solutions for Windows desktops. Desktop applications are generally self-contained applications whose non-OS dependencies are easily bundled within a single file system mount point, or self-contained directory.

It is usually advantageous to optimize an application before it is executed. Conventionally, such optimizations are performed at compile-time and/or runtime. However, only some optimizations can be performed at compile-time because the complete runtime environment is not known and/or cannot be guaranteed at the time of compiling. Similarly, only limited optimizations are performed at runtime because the cost of performing runtime optimization offsets any savings realized by the optimized code. Thus, runtime optimizations are typically performed only on sequences of code that are executed frequently. A discussion of code optimization (both at runtime and compile-time) can be found in “Compilers: Principles, Techniques, and Tools (Second Edition),” by A. Aho, et al. (Pearson Addison Wesley 2006).

Further, in the context of a virtual machine, it is important to be able to guarantee that a virtual machine has not been tampered with between the time that the virtual machine image was prepared and the time when the application itself is executed.

### SUMMARY OF THE INVENTION

One embodiment of the present invention provides a method for creating a virtual machine image. According to the method, at least one application is provided on a computer system. After the application is provided on the computer system, at least one optimization of the application is performed based on a runtime environment of the application to produce an optimized application, and the optimized application and at least a portion of the runtime environment are packaged in a virtual machine image. In one embodiment, the computer system is a virtual machine.

Another embodiment of the present invention provides a system for creating a virtual machine image. The system includes means for providing at least one application on a computer system, and means for performing at least one optimization of the application based on a runtime environment of the application, after the application is provided on the computer system, so as to produce an optimized application. The system also includes means for packaging the optimized application and at least a portion of the runtime environment in a virtual machine image.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 illustrates the Virtual Machine Monitor execution stack of two platforms of the Progressive Deployment System;

FIG. 2 illustrates the virtual and physical views of the Progressive Deployment System;

FIG. 3 illustrates the general organization of the Progressive Deployment System;

FIG. 4 illustrates the arrangement of metashards and shards;

FIGS. 5-7 are a flow diagram illustrating a process for creating a virtual machine image; and

FIG. 8 is a flow diagram of a prepare-time optimization process in accordance with one embodiment of the present invention.

### DETAILED DESCRIPTION

While the specification concludes with claims defining the features hereof that are regarded as novel, it will be better understood from a consideration of the following description in conjunction with the drawings, in which like reference numerals are carried forward.

The Progressive Deployment System (PDS) was developed by IBM Corporation. A detailed description of PDS is provided in U.S. Patent Application Publication No. US 2006/0047974, which is herein incorporated by reference.

PDS is a development tool which provides a virtual environment for executing self-contained software universes (virtual assets) in which all dependencies, except dependencies on the underlying operating system and hardware, have been resolved. PDS supports the Windows OS and has been used to deploy software development tools such as Eclipse and WebSphere Studio Developer, productivity environments such as Open Office and Lotus Workplace Client, and server stacks such as Apache and Tomcat.

An “asset” is a unit of software capable of being executed, corresponding to an executable plus its configuration information, extending to all the processes it creates and all the software and resources needed to support those processes. An asset contains the transitive closure of all of its dependencies except for the base operating system; thus, an asset is dependent only on the operating system. It should be understood that an asset will usually comprise a virtual machine monitor for an application virtual machine as well as an application virtual machine image.

A “shard” denotes an array of bytes that may be stored on disk. The shard is the atomic unit into which all assets are divided by PDS, and is the unit of sharing across assets. A shard is not self-describing and includes no meta-information; it is just bytes. The shards of an asset typically represent either files, discrete pieces of files such as the members of archives, or convenient units of metadata. But, most generally, they can represent any information that supports the asset's execution.

An “asset collection” is a collection of assets including the union of the shards of all of the assets in the collection. Within an asset collection there are no bitwise duplicate shards, and some shards may belong to more than one asset. The asset collection is the unit of preparation and deployment for PDS.

A “shard execution cache” (SEC) is a shard source that is read-only to virtualizers and contains the shards that the virtualizers need although not necessarily all the shards of any one asset collection.

A “virtualizer” (or “Virtual Machine Monitor”) is a component that intercepts some subset of an asset's communications with its supporting platforms such as the OS or a JVM. It redirects these requests so that significant resources are fetched from PDS instead of locally.

PDS intercepts a select subset of system calls on the target machine to provide a partial virtualization at the operating system level. This enables an asset's install-time environment to be reproduced virtually while otherwise not isolating the asset from peer applications on the target machine. Asset components, or “shards”, are fetched as they are needed (or they may be prefetched), enabling the asset to be progressively deployed by overlapping deployment with execution. Cryptographic digests may be used to eliminate redundant shards within and among assets. A framework is provided for intercepting interfaces above the operating system (e.g., Java class loading), enabling optimizations requiring semantic awareness not present at the OS level. PDS also allows deploying and managing complex software stacks. By treating assets as immutable and with their own view of their virtual file spaces, along with the ability to share components between assets, PDS allows multiple assets to simultaneously execute on the same machine. Components (shards) are assigned the same name if, and only if, they have the same content. This allows the efficient delivery of many virtual assets which share common sub-components.

With the exception of a small bootstrap code (the PDS player), PDS's own virtualizers are embedded in every asset. The shard design ensures that the duplication is avoided in the physical shard storage. This allows assets to be unaffected by subsequent PDS virtualizer evolution, further enhancing the ability to service and support deployed assets in the field. The end-user's perceived complexity of the deployed environment is lowered, because its internal structure is hidden from the user. Serviceability of deployed environments is enhanced because every asset represents an immutable state of some installed image, and no user can have an image that is in-between two supported virtual machine versions.

PDS uses a selective approach to process-level virtualization, which enables multiple assets to co-exist and interact as peers in the host machine environment without incurring a significant performance penalty. This enables multiple vendors to deploy different parts of a complex commercial environment, which would be difficult to accomplish with a full isolation sandbox approach based on a full-system VMM. On the other hand, PDS cannot isolate environments at an OS level the way that full-system VMMs can. Thus, the two approaches, system and application virtualization, are fundamentally complementary to one another.

High-level languages often use their runtime environments both to enhance the functionality of underlying hardware and OS, and to achieve portability across hardware and operating system implementations. Virtualization effectively masks the idiosyncrasies that arise within an operating system instance as individual machines are configured differently.

Assets are designed to be deployed progressively, meaning that the transfer of the asset's bits to the target machine is overlapped with its execution. This advantageously enables replacement racks, for example, on a server farm, to be rapidly provisioned without waiting for an entire system image to be moved to the machine prior to starting its execution. Since assets are logically immutable entities, the user is assured that every asset, once tested, will not later fail due to an incompatible update. Any change to an asset, no matter how small, results in a new asset.

Assets are preferably isolated from each other in the sense that each one sees its own unique resources, such as virtual files, directories, and system metadata, and not resources that are unique to some other asset. While assets cannot see any of the host machine's resources that were overlaid by their own virtual ones, they can see other local resources and can communicate with other programs running on the host machine including other assets running under PDS through the local file system and local interprocessor communication (IPC). The PDS virtualizer puts its assets on the same plane as ordinary programs by running above the OS rather than below it.

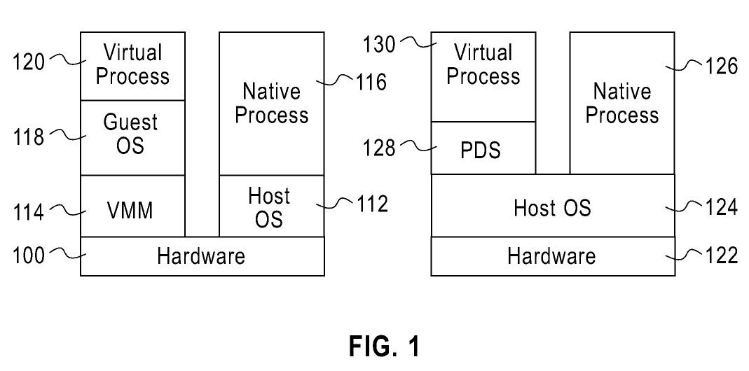

FIG. 1. illustrates the VMM execution stack of two platforms. Hardware 100 supports two stacks. One stack supports the execution of Host OS 112 supporting Native Process 116 and the other full-system VMM 114 executing Guest OS 118 which, in turn, is enabling Virtual Process 120. Hardware 122 supports a single Host OS 124 having two stacks. One supports the execution of Native Process 126 and the other PDS application VMM 128 running Virtual Process 130.

Without an effective mechanism for reducing redundancy between (as well as within) assets, the proliferation of virtual views would entail a prohibitive amount of space to store, and bandwidth to transport, many closely related assets. To address this, assets are partitioned into shards, variable-sized semantically determined “pages” that are the unit of transfer between a software repository and the host machine. Shards may correspond to files, semantically cogent portions of files, system metadata such as registry entries, or metadata used by PDS itself. Shards are freely shared across assets.

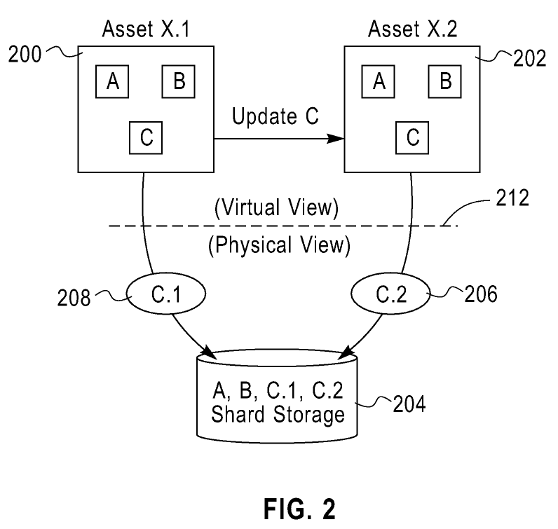

FIG. 2 illustrates the virtual and physical views of the PDS. In the virtual view, a first Asset X.1 at 200 contains shards A, B, and C. A second Asset X.2 at 202 also contains shards A, B, and C. In the physical view, bitwise identical shards are given the same physical name in storage 204 and are only stored once. Shards help maintain an appropriately scaled working set as the repertoire of assets in use on a machine evolves over time. Since they are semantically determined, they allow redundant parts of highly similar assets to be detected and shared transparently while maintaining the illusion that each asset has its own copy. Thus, the duplication implied by the virtual view (above boundary 212) of an asset's evolution is not reflected in its physical storage manifestation (below boundary 212). Two versions of Asset X differing in component C is only reflected in the underlying physical shard storage. A reference to C from Asset X.1 at 200 is mapped to shard C.1 at 208. A reference to C from Asset X.2 at 202 is mapped to shard C.2 at 206.

The separation between virtual and physical views of asset composition enables the internal structure of the asset (e.g., containing components A, B, and C) to be hidden from the end-user. The end-user only sees whole assets (Asset X.1, Asset X.2, etc.), and never needs to deal with lower level component patches, upgrades, versions, and/or configurations. Thus, end-users simply execute the whole asset version they are interested in, and the additional shards required for its execution will be transported automatically.

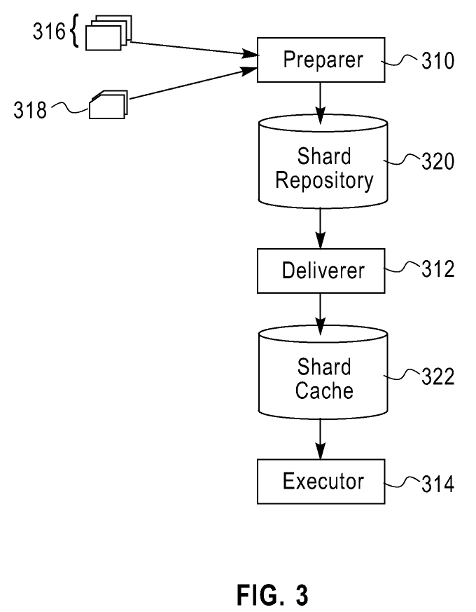

FIG. 3 illustrates the general organization of the PDS. The PDS is organized into three major components. In general, the Preparer 310 is a software plug-in within a preparation subsystem that serves the needs of a specific virtualizer. It produces assets from software that has been installed in the conventional fashion on a clean or otherwise empty machine (real or virtual). A capture phase, prior to preparation proper, is used to identify those components to prepare. Asset preparation consists of breaking assets into shards, and organizing assets and their shards into asset collections. These asset collections are deployed into shard repositories. The preparation subsystem is “offline” and communicates with the rest of PDS only indirectly via the asset collections that it produces.

The Deliverer 312 makes assets present on a host machine by ensuring the appropriate shards are on hand when needed. Delivery consists of moving bits between different shard sources with the goal of having them available in the SEC when needed by PDS virtualizers. The execution subsystem announces its needs to the delivery subsystem to ensure that needed shards are in the SEC. The delivery subsystem may copy shards, if necessary, from a shard repository to the SEC and, in some instances, through intermediate shard sources. The Executor 314 is the virtual execution environment which manages the execution of assets on the host machine. Typically, the Deliverer 312 will run in tandem with the Executor 314, although execution of the former could precede that of the later.

Preparer 310 accepts as input a virtual machine comprising installed applications 316 and PDS virtualizers 318, along with an instruction set, and it produces a shard repository 320 containing, in part, a launch document. The instructions given to the Preparer are an inventory of what is in the virtual machine plus a startup directive. Typical virtual machine inventories are a few directory/file trees but other kinds of system metadata may be listed. The startup directive is a command that executes on the target machine but inside the virtual environment in order to start the asset. Most assets have trivial startup directives, but they may alternatively be used to set environment variables or perform environment preparation not covered by the virtual machine's inventory.

The shard repository 320 is a file tree. Thus, within which each shard is a file. A shard does not necessarily have a predefined structure. Shards are assigned shard identifiers so that two shards with the same content will typically have the same shard identifier and two shards with different content will, with very high probability, not have the same shard identifier. (One way to achieve this is to us a cryptographic digest of a shard's contents as its identifier.) In the shard repository, the path names of shards can be algorithmically derived from their shard identifiers for efficient retrieval. Bitwise-identical shards need only be stored once. This has the advantage of avoiding the redundancies implied by every asset containing all of its dependencies. The contents of two virtual files that share the same bit pattern can be represented by the same shard. These files can, however, have different names, creation dates, permission attributes, etc. PDS reconciles this by storing file metadata in the metashards, and having the primary shards contain only the file contents.

The shard repository 320 produced by the Preparer 310 typically contains all of the shards of one or more assets under preparation. Primary shards are pieces of the application being prepared, or of its software dependencies, or of the PDS VMM as the pieces appear on the preparation machine. The preparation machine is an application virtual machine delivered as a PDS asset. Metashards contain control information generated by the Preparer and interpreted by the Executor. The redundancy avoidance enabled by the shard design also allows separately prepared repositories to be merged to form larger ones containing the shards of many assets but still storing each shard once. The Deliverer 312 (and sometimes the Executor 314) reads shards from shard repositories but does not mutate them in place. The Executor implements copy-on-write semantics for objects in the virtual machine.

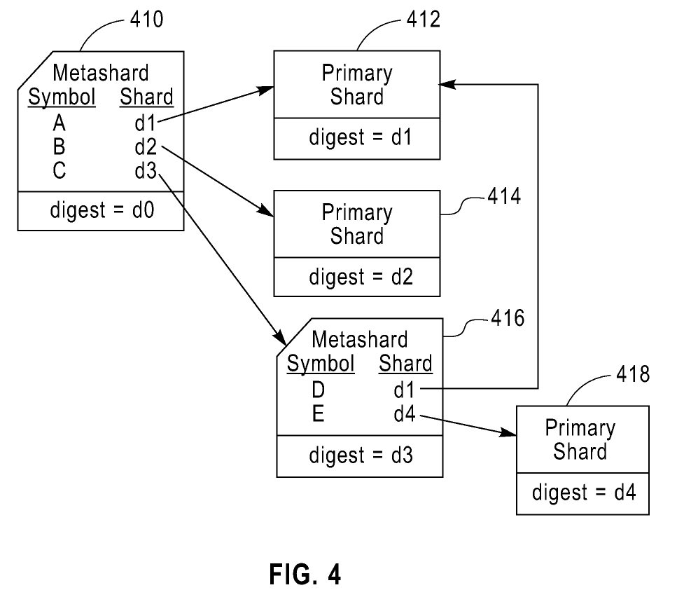

FIG. 4 illustrates the arrangement of metashards and shards. A metashard 410 generally comprises one or more symbols, with each symbol having its own shard identifier. Exemplary metashard 410 includes symbols A, B, and C having shard identifiers d1, d2, and d3, respectively. Every primary shard of an asset is referred to in at least one of the asset's metashards via its shard identifier. The metashards themselves form a tree linked by shard identifiers. Each identifier of the metashard at the root of this exemplary tree uniquely identifies the asset. For example, identifier d1 of metashard 410 identifies primary shard 412, identifier d2 of metashard 410 identifies primary shard 414, and identifier d3 of metashard 410 identifies another metashard 416. Metashard 416 includes symbols D and E. which are associated with identifiers d1 and d4, respectively. Identifier d4 of metashard 416 points to primary shard 418.

All assets are immutable once prepared. However, some assets may represent evolutions of others.

A launch document is a small document (not a shard) containing the asset identifier of an asset together with additional information that allows the Executor to interact with the Deliverer to obtain the shards of the asset. This information may specify the location of a shard repository containing the asset's shards. Although the interaction between the Deliverer and Executor is typically file-based, small shards can also be read directly into memory.

When the Executor 314 identifies the need for a particular shard, it passes the shard's identity to the Deliverer 312, which blocks the calling thread until it is able to manifest the shard as a file. At which point, the path name of that file is returned to the Executor. The Executor then uses standard OS interfaces, including memory-mapping, to utilize the shard without modifying the shard.

Because the shard repositories are just file trees, the Deliverer 312 can use file system capabilities already present in the OS to map shard repositories into the local file space. Alternatively, the Deliverer employs physical media such as DVDs. The Deliverer can copy shard repositories to local disk, or mount them as remote file systems. The problem of actually moving the bits is left to the file system technology employed. The Deliverer simply returns paths in the appropriate file system for each shard requested.

The Deliverer 312 can employ a specialized client-server algorithm to transfer shards from a remote shard-repository to a local shard cache 322 that contains only those shards needed on the local machine. In this case, the Deliverer can implement sophisticated working set maintenance algorithms and pre-fetching of shards based on learned execution patterns. It may also reorganize its shard repositories into alternate representations that do not use a file/shard relationship, for efficiency. A separable delivery subsystem enables alternative implementations to be plugged in that may be suitable for specific situations. The current PDS system implements two Deliverers, one file based, the other using the HTTP protocol and a standard servlet engine, with the latter allowing for experimentation with the pre-fetching strategies and operation in wide area networks without requiring the installation of specialized file system software.

The Executor 314 has a small bootstrap mechanism (PDS player) for launching the virtual machine on the client system, and the code to provide the execution environment.

PDS provides a virtualization that is selective to permit assets to inter-operate with other local applications via system APIs. PDS interposes a virtualizer between the application and the OS which will vary from OS to OS. The APIs that are intercepted in PDS's selective virtualization are just those needed to map the preparation machine onto the target machine as a virtual machine image. That is, they include the APIs that deal with files, directories, system metadata, and anything else that is found to be stored persistently at installation time. Although the bulk of these APIs are file-related, some virtual machines include information stored in specialized system databases not accessed via the file APIs (e.g., the Windows registry).

Virtual machine images may also include scattered files in system-managed directories, a pattern that cannot be duplicated via the hierarchical mounting capabilities of most operating systems. Finally, dynamic loading and dynamic binding between modules, although rooted in file I/O, has semantic details (search paths, versioning, etc.) that require additional intervention to ensure that the asset operates within its virtual machine image and is not contaminated by artifacts in the real system. These subtleties can prove problematic for the kind of deployment PDS enables through alternative approaches such as remotely mounting file trees directly on a host machine.

PDS only intercepts a small subset of the full Windows API, limiting its interception to certain file-related APIs, registry APIs and those related to dynamic loading and process creation. All of the graphics, interprocess communication, network I/O, thread synchronization, and message formatting APIs are left alone, causing a PDS asset to be, in most respects, a peer of other programs running on the OS. Even within the file APIs, path directed requests, in which files are designated by hierarchical names, are distinguished from handle directed requests, in which files are designated by previously opened handles. As is the case with many distributed file systems, the former is intercepted but (usually) not the latter, performing the necessary actions (including copying if necessary) at open time to avoid having to interfere with reads, writes, seeks, locking and synchronization. This is done not only for efficiency but also to permit the memory-mapping APIs of the OS to operate without the need for a fine-grained intervention by the virtualizer.

For those APIs that are intercepted, the virtualizer makes a decision based on path name, registry key, etc., as to whether the request falls within the virtual machine image or not. If it does, the request is handled. But, if not, the request is passed through unchanged to the operating system. Thus, PDS assets can communicate via the local file system with each other, with non-PDS programs, and with OS utilities.

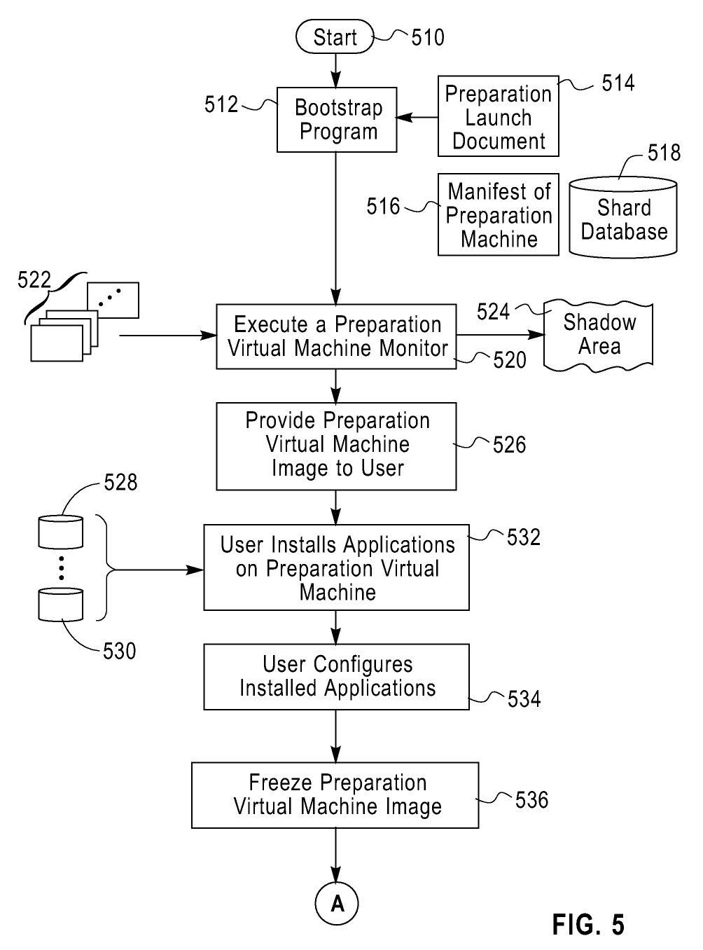

FIG. 5 is a flow diagram illustrating an exemplary process for creating a virtual machine image. The method starts at 510. At 512, the PDS player (i.e., bootstrap program) is loaded on the client machine. It uses a launch document 514 to bring down and execute a preparation Virtual Machine Monitor (VMM) at 520. The VMM starts recording changes to its machine. Artifacts created or modified by the VMM are deflected to a shadow area 524. Alternatively, the VMM records artifacts on the host machine that are not part of the preparation virtual machine. The VMM maintains the fiction that these artifacts are part of a shared environment between the virtual machine and the host machine.

The VMM preferably brings up a clean ‘empty’ bare virtual machine image which is presented to a user as a preparation virtual machine, at 526. The preparation virtual machine comprises both the preparation VMM and the preparation virtual machine image. PDS assumes that the OS of the preparation host machine is available on the user's client machine.

The preparation virtual machine is instrumented with data and other constructs necessary to support a virtual machine image. At 526, the preparation virtual machine is provided to the user and the user runs this preparation virtual machine as a normal PDS asset. The initial state of the preparation virtual machine has already been check-pointed. Normally the asset prepared is stripped of the functionality in the preparation asset used in its preparation. Alternatively, the prepared virtual machine includes some of the preparation functionality.

At 532, the user installs various applications 528 on this virtual machine at will (perhaps by acquiring installation files from a remotely mounted file system, or from over the network, or by some other means). This is alternatively achieved by dragging and dropping installation files into the preparation virtual machine. Registry entries and other system and environment variables can also be added either implicitly during the installation process or explicitly by the user.

The locations of application components and dependencies are specified in a preparation document 530. It is important that necessary artifacts (files, registry keys, values, and the like) required by the installed applications and their dependencies are also identified in the preparation document. Artifacts not required are not recorded because these do not have to be included in the new asset. Alternatively, the preparation virtual machine operates in a special mode in which it simply records all new files, registry entries, environment variables, and other artifacts created by the installed applications. A mechanism may be provided to assist the user in pruning unwanted artifacts.

The preparation virtual machine uses the information contained in the preparation document and walks the state of the preparation machine entering the shards into a database (typically on a remote server). A manifest is created which maps the hierarchical names used by the application for entities (files, etc.) into shard identifiers.

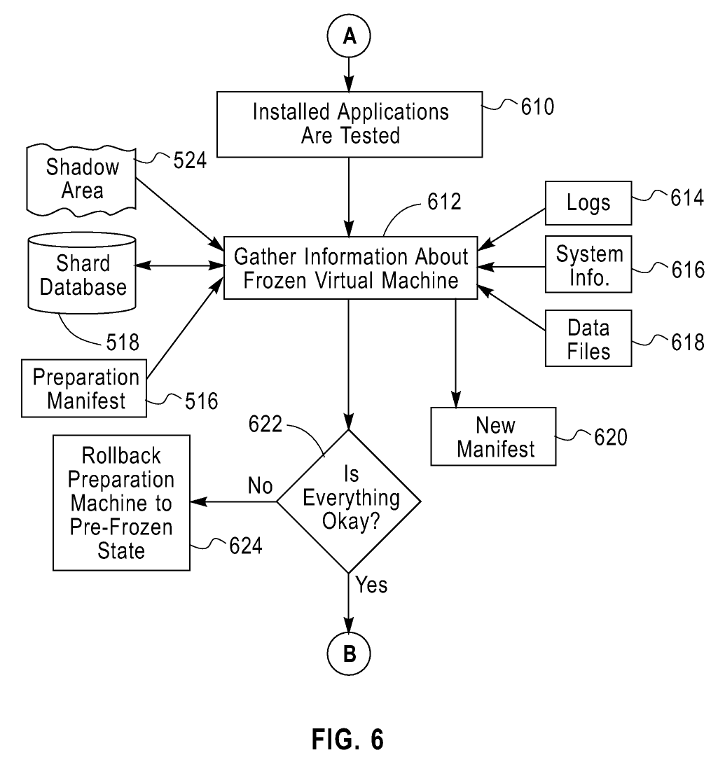

At 534, the user configures the installed application as desired. The VMM running the preparation virtual machine is instructed to freeze the virtual machine's state, at 536. As shown in FIG. 6, the installed applications can then be tested on the state of the frozen machine, at 610. If testing the installed applications occurred before the state of the virtual machine was frozen, then unwanted artifacts introduced by the testing process may be introduced into the state of the frozen machine. Once frozen, the user can test the installed applications at will. If dependencies, for example, needed by the installed application are not found during testing or the user has determined that an installed application does not run properly, then the frozen virtual machine can be unfrozen and the problem corrected. Importantly, unwanted artifacts that may have been generated or otherwise created during the testing process are not frozen in with the captured state of the virtual machine.

Next, at 612, there are gathered information and resources obtained since the creation of the bare preparation virtual machine. The artifacts stored in the VMM's shadow area 524 are obtained. This shadow area will contain artifacts from the underlying host environment that have been modified by the execution of the VMM. Artifacts that have been required but not modified (i.e., read) by the VMM are identified from special read logs maintained by the preparation VMM. System related information 616 and other information such as information regarding the preparation virtual machine itself are obtained.

From the gathered information, a determination is made at 622 as to whether or not anything is missing. If it is determined that some variable or dependency is not found, then the state of the preparation virtual machine can be rolled back to the state at which it was frozen at 624, and the preparation virtual machine is unfrozen. (For convenience, the read log need not be rolled back). If everything is okay then a virtual machine image can be created from the frozen preparation virtual machine.

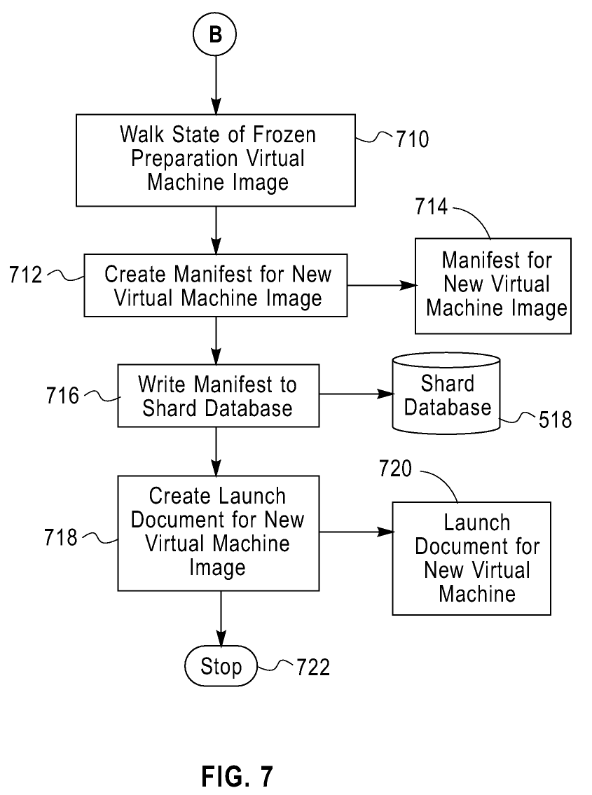

As shown in FIG. 7, at 712 a new manifest 714 is created which reflects the state of the preparation machine as it appeared to the user at the time it was frozen is created. This is based on the old manifest 516 of the preparation virtual machine, the contents of the VMM's shadow area, logs, and the rest of the information gathered in 612. The new manifest 714 is then used to map application names to identifiers for their respective shards. The newly mapped shards are stored in shard storage database 518. Alternatively, the new manifest is itself turned into a shard stored in the database.

The newly created virtual machine image of the frozen preparation virtual machine can then be written out. The virtual machine image is stored as a set of shards.

A launch document 720 is created for the new virtual machine image, at 718. This launch document is very much similar to the launch document 514 which was used by the PDS player in step 512 to bring up the virtual machine monitor (VMM) which launched the original preparation virtual machine. Once the virtual machine image is launched, the user will be presented with a virtual machine having the same state of the preparation virtual machine as it appeared to the user at the time it was frozen. The virtual machine image will be a new populated virtual application that encapsulates the applications installed, configured, and tested by the user. This virtual machine image can be run as a new PDS asset.

When the PDS player is run, the VMM brings down and executes the virtual machine image and any of its software dependencies that execution requires. The shards may be prefetched from the server into the client's local cache before they are required. Shards are cached on the client so that, if they are needed in the future, they are readily available locally. Allowing shards to be opened directly in the cache improves efficiency, when it is possible to do so, and is a key to achieving low overhead.

In a virtual machine such as the exemplary one described above, it is advantageous to optimize the applications installed on the preparation virtual machine. While conventional application optimization is performed at “runtime” and/or “compile-time”, embodiments of the present invention optimize an application at a different “time”. In particular, in embodiments of the present invention an application is optimized at “prepare-time”. Prepare-time optimizations are performed when an application is packaged as a virtual machine image.

As explained above, an application, its software dependencies, possibly an operating system, and possibly some or all of the code for a virtual machine monitor are typically combined together into a virtual machine image. As part of this process or directly preceding it (i.e., at “prepare-time”), various optimizations are performed on one or more applications that are part of the image (e.g., on the collection of artifacts that will eventually make up the image). Such prepare-time optimization enables the results of these optimizations to be preserved in the frozen virtual machine so that the benefits of the optimization are repeatedly realized.

Performing these optimizations at prepare-time is advantageous over performing runtime optimizations because the costs of the prepare-time optimizations can be amortized over all executions of all instances of the virtual machine image that is being prepared. Also, performing these optimizations at prepare-time is advantageous over performing compile-time optimizations because much more of the runtime environment is known and can be guaranteed at prepare-time.

Performing code optimization is often a matter of making trade-offs. For example, one trade-off is between code-size and performance. While optimized programs are usually faster, they are often also much larger. Code-size can limit the amount of optimization that is usually done at compile-time. In the context of a system like PDS in which the virtual machine image is partitioned into shards that can be delivered to a host machine when, and only if, they are needed, it is possible to overcome this limitation in some cases.

For instance, the same code may be optimized differently based on several different usage scenarios, but it may not be possible to determine which of these scenarios will be encountered until the application has been running for a while. The application can first execute in a “vanilla” mode that is not optimized for any one scenario, but which is instrumented to determine which scenario is actually encountered. After this determination has been made, the vanilla code branches to the code optimized for that scenario.

If the number of scenarios is small, then this optimization can be performed at compile-time. But, if the number of scenarios is large and the size of the optimized code for each scenario is also large, the size of the resulting code would prohibit this as a compile-time optimization. In contrast, with prepare-time optimization, each code fragment can be optimized for a different scenario and each of these code fragments can be packaged as a separate PDS shard. The vanilla code would cause the appropriate shard to be delivered to the host machine. In this way, only the vanilla code and the code optimized for the encountered scenario would ever be delivered to the host machine. Thus, the number of scenarios is no longer a limitation.

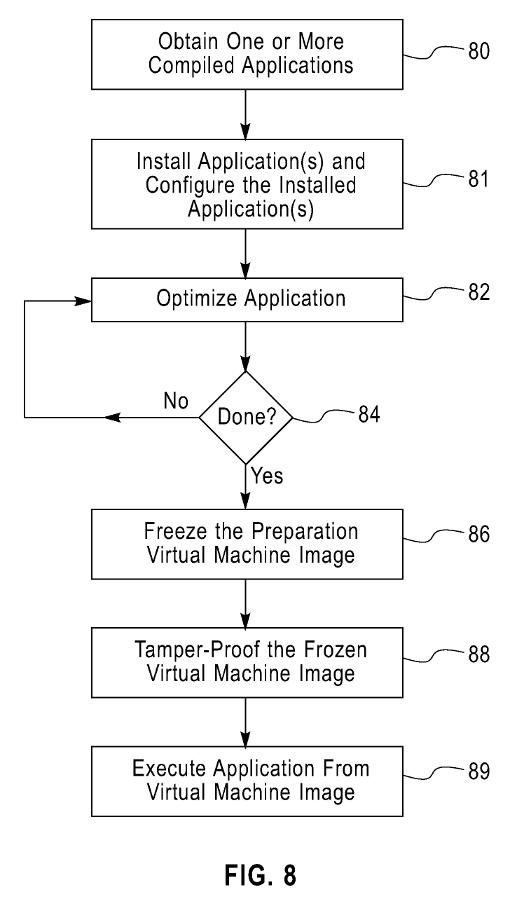

FIG. 8 is a flow diagram of a process for optimization of an application at prepare-time in accordance with one embodiment of the present invention. First, at 80, one or more compiled applications are obtained. For example, one or more of the applications can be developed, coded, and compiled. Further, one or more of the applications can be purchased as compiled code, or as source code and then compiled. Optionally, compile-time optimizations can be performed when the source code for one or more of the applications is compiled.

Next, at 81, all of the applications are installed, along with portions of their runtime environment, in the clean environment of a preparation virtual machine. For example, in one exemplary embodiment in which PDS is used, the applications are installed in the manner described above with respect to FIGS. 5-7. In some embodiments, one portion of the runtime environment that is installed is part or all of an operating system. Preferably, the installed applications are also configured for execution in their runtime environment at this time.

Then, at 82, one of the installed application is optimized using known and/or new optimization techniques. This is known as “prepare-time” optimization because it is performed as part of the process of combining together the application, its software dependencies and other parts of its runtime environments (such as an operating system and a virtual machine monitor) into a virtual machine image. One exemplary optimization process that can be performed at this time is to run the application at this time during preparation of the virtual image and perform the standard optimizations on the application that are usually performed at runtime. In other words, perform the usual runtime optimization process at prepare-time.

However, prepare-time optimization is not limited to only performing standard runtime applications; modified, different, or additional optimizations can be performed at prepare-time. For example, while only limited optimizations are usually performed at runtime because the cost of performing these optimizations immediately offsets the savings realized by these code optimizes, performing optimizations at prepare-time results in the optimizations being preserved in the virtual machine image. Thus, the benefits of the code optimizations are realized over and over again (i.e., each time the application is later run). In practical terms, this means that the optimizations that can be performed at prepare-time in the virtual machine preparation environment can be much more expensive in terms of time or computing power than those that are performed at runtime on the client machine.

As a specific example, an optimization process performed at runtime is usually only performed on code sequences that are executed very frequently. However, this same optimization process can be performed at prepare-time on other code sequences so that more or even all of the code can be optimized. Over the life of the virtual machine image, the optimization of this additional code can result in significant savings. While optimization usually increases the code size significantly, an embodiment that uses PDS as described above could mitigate this effect by only delivering an optimized code sequence when that sequence is first executed (or after the unoptimized sequence has been executed some number of times). In various embodiments, any other code optimizations can be performed instead of, or in addition to, the code optimizations described above.

Additionally, non-code optimizations can also be performed at prepare-time. For example, at runtime an application is typically scanned for malware (such as computer viruses) by the client computer. This is typically a relatively expensive process in terms of computing power. However, with prepare-time optimization, if the user trusts the provider of the virtual machine image containing the application, then the expense of scanning the application for malware can be completely transferred to the preparation environment. That is, the provider of the virtual machine image performs the optimization of scanning the application for malware at prepare-time, and then includes the already-scanned application in the virtual image, so that scanning by the client computer at runtime is redundant and can be eliminated. Thus, significant resources (i.e., CPU cycles) can be saved by the client computer. If the virtual machine is made tamper-proof as described below, the future reliability of the scanned virtual machine image is increased.

Another non-code optimization that can be performed at prepare-time is class verification in Java, which typically is a moderately expensive runtime operation. The rules of Java require that classes be verified when they are loaded (during the execution of a Java program) or that the executing program behave as if the classes were so verified. However, with prepare-time optimization, this class verification by the client computer at runtime can be eliminated. In particular, the preparer of the virtual image performs the optimization of verifying the classes at prepare-time, and then includes these verified classes as part of the virtual machine image. Again, if the virtual machine is made tamper-proof as described below, the future reliability of the classes in the virtual machine image is increased.

A further non-code optimization that can be performed at prepare-time is classpath search optimization. When a Java class is loaded at runtime, the classpath of the running Java program is searched to find an instance of the class in a fixed order. Finding a particular class can be a costly operation with the cost being proportional to the length of the path. At compile-time, the classpath is not known so optimization cannot be performed. If the classpath is part of the runtime environment that is known at prepare-time, the classpath can be optimized by being preprocessed to construct a constant-cost lookup mechanism (i.e., a fast classpath search mechanism) that can then be consulted at runtime to quickly locate the proper class to load. The cost of performing such an optimization (i.e., constructing a lookup mechanism) at runtime when the classpath is known is usually prohibitive.

In various embodiments, any other optimizations can be performed instead of, or in addition to, the optimizations described above. For example, in some forms of virtualization (e.g., system virtualization), an operating system is typically packaged in a virtual machine image along with one or more applications. At prepare-time, static analysis of the installed application(s) can be performed to determine if any of the services provided by the operating system are not needed by the installed application(s). If such services are found, the code for these services can be eliminated from the operating system in the virtual machine image, thus reducing its footprint and providing new opportunities for classical compiler optimization. Furthermore, analysis may discover opportunities for safely integrating application code into the operating system and vice versa in order to eliminate some of the expensive boundary crossings between the two. This optimizes the application that is later run from the virtual machine image, and also can provide new opportunities for classical compiler optimizations.

After the application is optimized, it is determined if there is another installed application to be optimized, at 84. If so, another application is optimized, at 82. If not, the preparation virtual machine image is frozen, such as in the manner described above with respect to FIGS. 5-7, at 86. Thus, the virtual machine image that is saved for distribution includes one or more applications that have already been optimized, so that the savings due to this optimization will be realized each time the application is executed from the virtual image. Additionally, because this optimization was performed at prepare-time, much or all of the runtime environment was known and could be guaranteed when the optimization was performed.

Next, in this exemplary embodiment the frozen virtual machine is made tamper-proof, at 88. This is done to guarantee that the application in the virtual machine image is not tampered with between prepare-time, when the optimization of the application is performed, and runtime, when the application is executed from the virtual image by the user. Tamper-proofing the virtual machine image requires a tamper detection mechanism and a virtual machine monitor (VMM) that invokes this mechanism. The VMM will refuse to run the application if the tamper detection mechanism detects any tampering. In embodiments of the present invention, various tamper detection techniques are used.

For example, in one embodiment utilizing PDS, the tamper-proof virtual machine image is composed of multiple shards glued together by one or more metashards (which are themselves shards) forming a manifest. The shards are identified by a cryptographic digest of their contents, and the digest is recomputed when a shard is first used. (In another embodiment, this digest is recomputed every time the shard is used.) If the computed digest does not match the result stored in the cryptographic digest, the VMM refuses to execute. In another embodiment, tamper detection is provided by preparing the virtual machine image as a monolithic whole, and computing a cryptographic digest of the whole virtual machine image. This digest is associated with an identifier for the image and maintained at an accessible place (e.g., on the same network). Before mounting the virtual machine image and/or executing any application from the virtual machine image, the VMM recomputes the digest for the whole virtual machine image and determines if it matches the known cryptographic digest. If these do not match, the virtual machine image is not mounted and/or the application is not executed. Through such tamper-proofing of the virtual machine image, it is guaranteed that the optimized application(s) will not be executed unless the bits that are to be executed exactly match those that were prepared.

Then, the tamper-proofed virtual machine image that includes the optimized installed application(s) is distributed to users. Each user can then run the installed application(s) from the virtual machine image on their client computer, at 89. While further runtime optimization could be performed at this time, it is typically deemed unnecessary as the application was already optimized at prepare-time before being frozen in the virtual machine image. Further, all of the savings due to the optimizations performed at prepare-time are realized each time the application is run on the client computer, without any further optimization costs. Thus, the savings seen by the user can be substantial.

In some embodiments, the VMM monitors execution to allow further optimization of the application in subsequent versions of the virtual machine image. For example, the VMM can instrument the collection of artifacts that goes into the virtual machine image to obtain performance relevant information, such as relative execution frequencies of different blocks of the code. The VMM reports this information to the preparation environment in some manner (e.g., by sending through the Internet to a central location). This information is then used at prepare-time of a subsequent version of the virtual machine image to determine if new, different, or further optimizations of the application should be made for the next version of virtual machine image that is distributed.

Other embodiments of the present invention are not based on PDS technology. While virtual machine images under PDS do not include an operating system because PDS assumes the operating system to be in place on the host machine, in these embodiments a virtual machine image is produced that does include an operating system.

In one such embodiment, source code for one or more applications, the libraries on which they depend, and an operating system is first gathered. Then, “prepare-time” optimization is performed as part of the process of combining together the application(s), the library dependencies, and the operating system into a virtual machine image. In this exemplary embodiment, a full range of code optimizations is performed on the ensemble of source code by an optimizing compiler using compile-time techniques with minor extensions to take advantage of having the complete code ensemble to optimize at once.

Additionally, dead code elimination is used to get rid of parts of the libraries and operating system that are unreachable from the application(s), and inlining is used to integrate library code into the application code. Other similar techniques can also be used to avoid costly boundary crossings between user and operating system code. This allows limited operating system functionality to be executed in user space when it is determined that doing so will not change the observable behavior of the code ensemble. Similarly, innocuous portions of the application (and/or library) code can be subsumed into the operating system. After all desired optimizations are performed, the optimized code for the whole ensemble is packaged as a virtual machine image.

In some embodiments, optimization choices are in part based on profile information. Such information can be gathered by running the application(s) at prepare-time. Alternatively, such information can be obtained in the form of traces of the specially instrumented versions of the application(s) (and/or of the libraries and/or operating system). Instrumentation code is added to the code ensemble being packaged as a virtual machine image, so that when the application(s) execute as a part of this virtual machine image, a trace is produced that can be used to help optimize the application(s) in a future virtual machine image.

Accordingly, embodiments of the present invention provide systems and methods for performing optimization of an application at prepare-time, which is just before or during “preparation” of a virtual machine image that contains the application. Unlike runtime optimizations, the cost of these prepare-time optimizations is amortized over all executions of the application from the virtual machine image. Further, much more of the runtime environment is known and can be guaranteed at prepare-time than at compile-time. Preferably, the virtual machine image containing the optimized application is made tamper-proof so as to guarantee that the application is not tampered with between prepare-time and runtime.

The present invention can be produced in hardware or software, or in a combination of hardware and software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means.

According to the inventive principles as disclosed in connection with the preferred embodiment, the present invention and the inventive principles are not limited to any particular kind of computer system but may be used with any general purpose computer arranged to perform the functions described and the method steps described. The operations of such a computer may be according to a computer program contained on a medium for use in the operation or control of the computer. The computer medium, which may be used to hold or contain the computer program product, may be a fixture of the computer such as an embedded memory or may be on a transportable medium such as a disk.

The present invention is not limited to any particular computer program or logic or language, or instruction but may be practiced with any such suitable program, logic or language, or instructions. Without limiting the principles of the present invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network that allows a computer to read such computer readable information.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for creating a virtual machine image, said method comprising the steps of:
providing at least one application on a computer system;
after the application is provided on the computer system, performing at least one optimization of the application based on a runtime environment of the application to produce an optimized application; and
packaging the optimized application and at least a portion of the runtime environment in a virtual machine image.

2. The method as defined in claim 1, wherein the computer system is a virtual machine.

3. The method as defined in claim 1, wherein the providing step comprises installing the application which has already been compiled.

4. The method as defined in claim 1,
wherein the providing step comprises obtaining the source code for the application, and
the step of performing at least one optimization comprises compiling the application.

5. The method as defined in claim 1, wherein the step of performing at least one optimization includes the sub-steps of:
performing at least one code optimization of the application; and
performing at least one non-code optimization of the application.

6. The method as defined in claim 5, wherein the at least one non-code optimization comprises at least one of scanning the application for malware and verifying at least one Java class.

7. The method as defined in claim 5,
wherein the application is a Java application,
the at least one non-code optimization comprises constructing a fast classpath search mechanism, and
the portion of the runtime environment that is packaged in the virtual machine image includes the classpath of the application.

8. The method as defined in claim 1,
wherein the portion of the runtime environment includes at least a portion of an operating system, and
the step of performing at least one optimization comprises at least one of:
removing code for at least one service of the operating system that is not required for execution of the application,
inlining code of the operating system into code of the application, and
subsuming code of the application into code of the operating system.

9. The method as defined in claim 1, further comprising the steps of:
partitioning the virtual machine image into a plurality of pieces; and
delivering at least one piece of the virtual machine image to a client computer after the client computer begins executing the virtual machine image.

10. The method as defined in claim 1, wherein the virtual machine image includes instrumentation code for obtaining information on performance of the optimized application for use in subsequent optimization of the application.

11. A machine-readable medium containing an instruction set executable by a computer system for creating a virtual machine image, said instruction set comprising instructions for:
providing at least one application on a computer system;
after the application is provided on the computer system, performing at least one optimization of the application based on a runtime environment of the application to produce an optimized application; and
packaging the optimized application and at least a portion of the runtime environment in a virtual machine image.

12. The machine-readable medium as defined in claim 11, wherein the computer system is a virtual machine.

13. The machine-readable medium as defined in claim 11, wherein the providing of at least one application on the computer system comprises installing the application which has already been compiled.

14. The machine-readable medium as defined in claim 11,
wherein the providing of at least one application on the computer system comprises obtaining the source code for the application, and
the performing of at least one optimization includes compiling the application.

15. The machine-readable medium as defined in claim 11, wherein the performing of at least one optimization comprises:
performing at least one code optimization of the application; and
performing at least one non-code optimization of the application.

16. The machine-readable medium as defined in claim 11, wherein said instruction set further comprises instructions for:
partitioning the virtual machine image into a plurality of pieces; and
delivering at least one piece of the virtual machine image to a client computer after the client computer begins executing the virtual machine image.

17. The machine-readable medium as defined in claim 11, wherein the virtual machine image includes instrumentation code for obtaining information on performance of the optimized application for use in subsequent optimization of the application.

18. A system for creating a virtual machine image, said system comprising:
means for providing at least one application on a computer system;
means for, after the application is provided on the computer system, performing at least one optimization of the application based on a runtime environment of the application to produce an optimized application; and
means for packaging the optimized application and at least a portion of the runtime environment in a virtual machine image.

19. The system as defined in claim 18, wherein the computer system is a virtual machine.

20. The system as defined in claim 18, wherein the means for performing at least one optimization performs at least one code optimization of the application, and performs at least one non-code optimization of the application.
